(19) United States
(12) Patent Application Publication
(10) Pub. No.: US 2025/0328235 A1
(43) Pub. Date: Oct. 23, 2025

(54) Electronic Devices and Corresponding Methods for Transferring Application Operations Between Devices Using Swipe Gestures

(71) Applicant: Motorola Mobility LLC, Chicago, IL (US)

(72) Inventors: Amit Kumar Agrawal, Bangalore (IN); Jing Li, Beijing (CN); Brian Patrick Kennedy, Chicago, IL (US)

(21) Appl. No.: 18/657,517

(22) Filed: May 7, 2024

Related U.S. Application Data
(63) Continuation of application No. PCT/CN2024/088412, filed on Apr. 17, 2024.

(51) Int. Cl. G06F 3/0488; G01S 13/02

(52) U.S. Cl. CPC G06F 3/0488; G01S 13/0209

(57) ABSTRACT

An electronic device includes a user interface, a communication device, and one or more processors operable with the user interface and communication device. The one or more processors, in response to the user interface receiving a swipe gesture across a surface of the user interface, prioritize a plurality of companion electronic devices as a function of at least one predefined criterion to select a companion electronic device and cause the communication device to transfer operation of a foreground application operating on the one or more processors to the companion electronic device selected.

### CROSS REFERENCE TO PRIOR APPLICATIONS

This application is a continuation claiming priority and benefit under 35 U.S.C. § 120, pursuant to 35 U.S.C. § 365(a), to PCT Application Ser. No. PCT/CN2024/088412, filed Apr. 17, 2024, which is incorporated by reference for all purposes. See MPEP § 1895.

### BACKGROUND

### Technical Field

This disclosure relates generally to electronic devices, and more particularly to electronic devices having wireless communication circuits.

### Background Art

Portable electronic devices are becoming smaller and smaller. A mobile phone configured only to make voice calls was the size of a shoebox not too long ago. Now, smartphones that can surf the web, maintain calendars, capture pictures and videos, send and receive text and multimedia messages, determine geographic location, and monitor health, in addition to making voice calls, slip easily into a pants pocket.

This evolution towards smallness is not entirely free of complication, however. As electronic devices get smaller, their user interfaces can be difficult to see. Text can become difficult to read due to small displays. Sounds can be difficult to hear due to small acoustic transducers, and so forth. It would be advantageous to have improved methods and systems that allow for small user interfaces without sacrificing a user's ability to consume content.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIGS. 1A-1E illustrate one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to transferring, by one or more processors of an electronic device in response to a user interface receiving a swipe gesture across a graphical user interface of an application operating on the one or more processors while a plurality of companion electronic devices are operating with an environment of the electronic device, operation of the application to a companion electronic device the one or more processors select as most optimized to operate the application. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to a user interface receiving a swipe gesture across the surface of a user interface, prioritizing a plurality of companion electronic devices as a function of at least one predefined criterion to select a companion electronic device from the plurality of companion electronic devices and thereafter causing a communication device to transfer operation of a foreground application operating on the one or more processors to the companion electronic device that is selected. The non-processor circuits may include, but are not limited to, a radio receiver, a radio transmitter, signal drivers, clock circuits, power source circuits, and user input devices.

As such, these functions may be interpreted as steps of a method to perform, in response to the receipt of a swipe gesture by a user interface of an electronic device requesting transfer of a foreground application of an application stack to a companion electronic device operating in an environment of the electronic device, selecting the companion electronic device from the plurality of companion electronic devices as a function of a selection criterion and, in response to the swipe gesture, causing a communication device, by the one or more processors of the electronic device, to transfer the operation of the foreground application of the application stack to the companion electronic device selected using the selection criterion. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that various embodiments described below are actuated using a swipe gesture or, alternatively, a “fling” gesture. As used herein, a “fling” gesture is a form of swipe gesture that has a faster initial movement across the user interface and a more abrupt stop of the movement via a stoppage of the object initiating the fling gesture on the user interface of the electronic device or, alternatively, a lifting of the object from the user interface. Embodiments of the disclosure contemplate that transfer of a foreground application of an application stack to a companion electronic device can be initiated by either a swipe gesture or a fling gesture, with the latter having an acceleration condition and deceleration condition that the former does not have. Thus, if one wanted to reserve the use of a swipe gesture for operations within the device, but needed a distinguishing factor to execute transfer operations, one could reserve the fling gesture for transfer operations and reserve the swipe gesture for on-device operations. Thus, while swipe gesture is used below to illustrate embodiments of the disclosure, it should be understood that “fling gesture” could be substituted for swipe gesture in any embodiment, with that substitution incorporating an acceleration threshold pre-condition and/or a deceleration threshold pre-condition.

Embodiments of the disclosure contemplate that mobile electronic communication devices are now used daily by billions of people. Users employ such devices many different purposes including, but not limited to, voice communications, text messaging, Internet browsing, calendar management, commerce such as banking, and social networking.

Embodiments of the disclosure also contemplate that as these devices have become more sophisticated, in some instances they have also become more complicated to operate. Illustrating by example, many “smart devices” now come equipped with touch sensitive displays rather than physical keyboards. While touching a surface is considered by some to be a simpler operation than working a complex keyboard, executing complex operations can require the navigation of several different menu tiers or user interface levels. Accordingly, embodiments of the disclosure contemplate that it would be advantageous to have simplified systems and methods for executing complex operations in modern electronic devices.

For instance, imagine that Amit has been listening to his favorite music streaming service on his smartphone to pass the time during his train ride to work. When he finally arrives at his desk, rather than continuing to deplete the battery of his smartphone, he would prefer to control the continuation of the Buster's Bluesman song to which he is listening, Chuck's Bone Gnawing Blues, from his computer. However, to do so, he must unlock his smartphone, navigate through several menus to find the music streaming application, navigate through more menus to find the settings and devices menu, and ultimately find the transfer icon to transfer control of the music streaming service from smartphone to computer. This can be tedious and time consuming. Indeed, in many cases Amit may see the task as so cumbersome that he avoids facing the navigation situation and instead causes the battery of his smartphone to just run out of blues driving juice.

Advantageously, embodiments of the disclosure provide a solution to this dilemma by providing Amit with a simple, intuitive, and quick way to transfer the operation of an application from a first electronic device to a second electronic device. In one or more embodiments, to transfer the operation of an application from a first device to a second device, all Amit needs to do is swipe his finger toward along the user interface of the transferring device (as noted above, a fling gesture can be used instead of a swipe gesture where desired). In one or more embodiments, when this occurs, one or more processors of the smartphone select a companion electronic device of the plurality of companion electronic devices operating within an environment of the electronic device as a function of at least one predefined criterion. Thereafter, the one or more processors transfer operation of the application operating on the one or more processors to the companion electronic device.

In one or more embodiments, the at least one predefined criterion identifies which companion electronic device is most optimized to operate the application. In this illustrative example, the application is a streaming music application. If the companion electronic devices operating within the environment are a computer (with large speakers), a printer, a smartwatch, and a thermostat, the device most optimized to continue the operation of the music streaming service would be the computer due to its larger speakers, combined with the fact that the printer, smartwatch, and thermostat either do not have speakers or have speakers inferior to that of the smartphone. Accordingly, regardless of which direction Amit's swipe gesture or fling gesture takes across the surface of the user interface, the one or more processors select the computer as the appropriate device to operate the music streaming application since the one or more processors determine, from the at least one predefined criterion, that the computer is the most optimized to operate the music streaming application. Advantageously, this occurs instantly and without interruption in Mac's Chicken Shack Boogie Woogie. This allows Amit to save the energy in his smartphone battery without missing a single beat of Chuck's bone gnawing fun.

In one or more embodiments, a method in an electronic device comprises receiving, by a user interface, a swipe gesture (or fling gesture) across a graphical user interface of an application operating on one or more processors of the electronic device while a plurality of companion electronic devices is operating within an environment of the electronic device. In one or more embodiments, the method comprises selecting, by the one or more processors, a companion electronic device of the plurality of companion electronic devices operating within the env of the electronic device as a function of at least one predefined criterion. Thereafter, the method comprises transferring, by the one or more processors using a communication device in response to the swipe gesture or fling gesture, operation of the application operating on the one or more processors to a companion electronic device identified as most optimized to operate the application by the one or more processors.

In one or more embodiments, the at least one predefined criterion comprises a proximity to, and orientation of, the electronic device in three-dimensional space relative to the companion electronic device. The proximity can be determined, for example, using an ultra-wideband ranging process or a Bluetooth™ channel sounding process. Other techniques for determining proximity will be obvious to those of ordinary skill in the art having the benefit of this disclosure. Thus, in one or more embodiments the one or more processors determine a proximity and direction in which the user of the electronic device is facing by evaluating the user's direction using ultra-wideband ranging to determine angle of arrival. Some embodiments of the disclosure presume that a user will be facing, and near to, the companion electronic device that is most optimized to operate the application. Thus, in one or more embodiments proximity and distance are used as the at least one predefined criterion.

In other embodiments, the at least one predefined criterion comprises a determination of which companion electronic device of the plurality of companion electronic devices is most optimized to operate the application. Illustrating by example, if the application is a productivity application, such as a spreadsheet or word processing document, the one or more processors of the transferring device may conclude that it is better to transfer such a productivity application to a computer with a keyboard or larger monitor so that the user may more readily work on the spreadsheet or document. By contrast, if the application is a movie streaming application or entertainment application, the one or more processors may conclude that a television or projector would be a better companion electronic device to operate the application. If the application is a gaming application, the one or more processors may conclude that a companion electronic device having a dedicated gaming controller attached would be better to operate the gaming application, and so forth.

Thus, if the application comprises a music application, the one or more processors may conclude that a music player is more optimized to operate the application than, say, would be a computer or electronic device operable by a gaming controller. By contrast, if the application comprises a productivity application, the companion electronic device may comprise a computer. If the application comprises a gaming application, the selected companion electronic device may be a companion electronic device that is operable with a dedicated gaming controller, and so forth. If the application comprises an audio/visual application, the companion electronic device may be a television for instance.

In still other embodiments, the at least one predefined criterion comprises a usage history of the application. Embodiments of the disclosure can determine which companion electronic device to transfer an application as a function of learning when a particular application was transferred to a companion electronic device, such as a larger display or device having larger speakers, in the past, such as at a particular time of day or during the week. Thus, in one or more embodiments the usage history is defined by a selected companion electronic device to which the operation of the application has been transferred from the electronic device in the past. In one or more embodiments, the usage history is further defined by a time of day at which the operation of the application was transferred from the electronic device to the selected companion electronic device in the past.

In one or more embodiments, a method in an electronic device comprises determining that an electronic device is connect with a plurality of electronic devices, with at least some of those electronic devices being from a different category of devices than other electronic devices. For instance, a video monitor may be in a visual display class of electronic devices, while a loudspeaker is in an aural class of electronic devices, and so forth. Similarly, a computer, such a side activity laptop computer or tablet computer, may be in a first class of devices referred to as computing devices, while a television or video monitor may be in a second class of devices referred to as display devices, with a smartphone being in a third class of devices referred to as secondary user devices. These are examples only, and other types and classes of electronic devices will be obvious to those of ordinary skill in the art having the benefit of this disclosure.

In one or more embodiments, the method transfers operation of an application operating on one or more processors of an electronic device using an intuitive swipe gesture or fling gesture as a function of one or more of the following: proximity and direction in which a person delivering the swipe gesture or fling gesture is facing, a category of applications to which the application being transferred is associated, and/or past usage of the application being transferred.

Illustrating by example, in one or more embodiments one or more processors of the electronic device evaluate, in response to a user interface receiving a swipe gesture or fling gesture, a user's direction using an ultra-wideband ranging process based upon angle of arrival. From this information, the one or more processors can select a particular electronic device from the plurality of electronic devices operating within the environment of the electronic device and can transfer, using a communication device of the electronic device, operation of the application to the companion electronic device selected.

In other embodiments, the one or more processors may select the companion electronic device to which the application is to be transferred using the category of applications to which the application is associated. If, for example, the application to be transferred is a productivity application, such as a word processing document or a spreadsheet, the one or more processors of the transferring electronic device may select a computer to transfer the application to in response to a swipe gesture or fling gesture since such a computer is likely to have a mouse or other user controls suitable for navigating such an application. By contrast, if the application to be transferred is a video streaming application or an entertainment application, the one or more processors of the transferring device may select a television for transfer in response to a swipe gesture or fling gesture. If the application to be transferred is a gaming application, the one or more processors may select to transfer the application to a device having a gaming controller attached thereto in response to a swipe gesture or fling gesture, and so forth.

In still other embodiments, selection of the companion electronic device to which transfer of an application in response to a swipe gesture or fling gesture will occur can be based upon past usage of the application. In one or more embodiments, the one or more processors of the transferring electronic device can select a companion electronic device to which the application will be transferred based upon machine learning that the application has operated on a particular device at a particular time of day or particular day of the week. Of course, these factors are illustrative only, as other factors will be obvious to those of ordinary skill in the art having the benefit of this disclosure. Moreover, these illustrative factors can be used in alone or in combination.

In one or more embodiments, an electronic device comprises a user interface, a communication device, and one or more processors operable with the user interface and the communication device. In one or more embodiments, the one or more processors, in response to the user interface receiving a swipe gesture (or fling gesture in other embodiments) across a user interface of the electronic device, prioritize a plurality of companion electronic devices as a function of at least one predefined criterion to select a companion electronic device from the plurality of companion electronic devices and cause the communication device to transfer operation of a foreground application operating on the one or more processors to the companion electronic device selected. In one or more embodiments, the one or more processors can further cause the communication device to recall the operation of the foreground application from the companion electronic device in response to the user interface receiving another gesture input.

In one or more embodiments, a method in an electronic device comprises receiving, by a user interface, a swipe gesture instructing one or more processors of the electronic device requesting operation of a foreground application of an application stack to be transferred to a companion electronic device operating in an environment of the electronic device. In one or more embodiments, the method comprises selecting, by one or more processors, the companion electronic device from a plurality of companion electronic devices operating in the environment as a function of a selection criterion. In one or more embodiments, in response to the swipe gesture, the one or more processors cause operation of the foreground application of the application stack to be transferred to the companion electronic device selected using the selection criterion.

As noted above, the selection criterion can comprise a proximity to, and orientation of the electronic device relative to, the companion electronic device. In other embodiments, the selection criterion can comprise which companion electronic device of the plurality of companion electronic devices is optimized to operate the application. In still other embodiments, the selection criterion can be a transfer history of the application from the electronic device. As also noted above, these factors can be used alone or in combination.

Advantageously, when the companion electronic device comprises one electronic device of a plurality of electronic devices operating within the environment of the electronic device, this intelligent selection of a particular companion electronic device from a plurality of companion electronic devices operating within the environment allows the one or more processors of the electronic device to intuitively and seamlessly determine to which companion electronic device operation of the application should be transferred.

Since operation of the foreground application is being transferred to a companion electronic device in response to the swipe gesture, in one or more embodiments the one or more processors can then surface a penultimate application of an application stack as a new foreground application after the transfer. Thus, if Amit was listening to a music streaming service that was operating as a foreground application of an application stack, with an email application serving as the penultimate application of the application stack, in one or more embodiments the one or more processors can cause the email application to surface as the new foreground application after the music streaming service is transferred to the companion electronic device identified by the swipe gesture.

Advantageously, embodiments of the disclosure just make life easier. For instance, consider the situation where Amit is sitting at his desk with his smartphone lying flat on the desk next to his computer. Now imagine that there is a summary view of information being presented on the smartphone. With a single swipe gesture across the touch-sensitive display of the smartphone, Amit can transfer the presentation of the summary view of information to the computer to make it easier to interact with this information on the screen of his computer. Advantageously, he is able to do this without even picking up his smartphone!

In still other situations, embodiments of the disclosure can be used to perform “drag and drop” operations. For instance, imagine that over the weekend Amit took a lot of photos of a hiking trip that he took with his family. When putting together a slide show of the trip to share with a friend, in one or more embodiments Amit is able to use the swipe gesture or fling to cause photos depicted on the display of his smartphone to slide over to a larger display that is visible to the friend. No longer does Amit need to download photos from a cloud application to the larger display device. Instead, he merely executes a swipe gesture to cause those photos to “magically fly” over to the display device.

Embodiments of the disclosure even contemplate that users like Amit could benefit from a visual understanding of what is happening when a foreground application is being transferred to another electronic device identified by a swipe gesture. Accordingly, in one or more embodiments one or more processors of the electronic device transferring operation of the foreground application to the other electronic device cause an animation of a graphical user interface of the application to move on the user interface of the transferring electronic device along the directional vector defined by the swipe gesture while the communication device transfers operation of the foreground application to the other electronic device. Advantageously, this provides a visual indication to Amit that the foreground application is slipping the surly bounds of the transferring electronic device to touch the hand of the companion electronic device to which it is being transferred, to adapt a phrase.

Embodiments of the disclosure thus advantageously allow simplified, fast, and streamlined techniques for interacting with friends and family. To illustrating by example, imagine that Liz's fiancé, Dan, does not have a venue viewing application that Liz wants him to check out so they can confirm their wedding plans. In one or more embodiments, Liz is able to use a swipe gesture to transfer the content rendering application component of the venue viewing application to Dan's smartphone. Embodiments of the disclosure contemplate that the transfer of this rendering component can be independent of other components of the application. Thus, in one or more embodiments the content generating application component of the venue viewing application can remain operational on Liz's smartphone while the content rendering application component is transferred to Dan's smartphone.

In effect, the application's content generating (i.e., processor intensive) components are running on Liz's smartphone while the displaying components (which use less processing power) are running on Dan's smartphone. If the navigational application component remains operational on Liz's smartphone, this would allow Liz to interact with the content being rendered on Dan's smartphone. Dan, to his chagrin, may not be able to interact with the content, but can view Liz's interactions that will soon lead to their wedded bliss.

In other, more equitable situations, embodiments of the disclosure contemplate that the swipe gesture can lead to the transfer of a second instance of a foreground application from a first device to a second device. Illustrating by example, in other embodiments Liz may transfer an instance of a foreground application to Dan's smartphone so that they can both interact with the venue viewing application independently. In such a situation, embodiments of the disclosure contemplate that Liz's smartphone may be hosting two instances of the same application, with a content rendering application component and navigation application component of one instance being operational on Dan's smartphone.

As noted above, the one or more processors may animate movement of a graphical user interface of the foreground application out of the application stack during the transfer to provide a visual indicator to the user that operation is being transferred from one electronic device to another. Other operations can be performed as well, including providing haptic feedback to a user when the transfer is complete, e.g., by vibrating the electronic device, by providing additional animations such as bubbling and expansion on the receiving device, and so forth. Still other additional operations will be obvious to those of ordinary skill in the art having the benefit of this disclosure.

Advantageously, embodiments of the disclosure provide electronic devices and corresponding methods that allow a user to effortlessly transition a mobile application from one smartphone to another. In one or more embodiments, this occurs with a continuity of media rendering with no stoppage or restarting of the application being transferred required. This advantageously allows a user to transfer applications from one device to another without any user experience “friction.” Moreover, it allows the user to maintain their experience immersion since the content keeps on playing with no need to pause, stop, or restart.

Other advantages offered by embodiments of the disclosure will be described below. Still others will be obvious to those of ordinary skill in the art having the benefit of this disclosure.

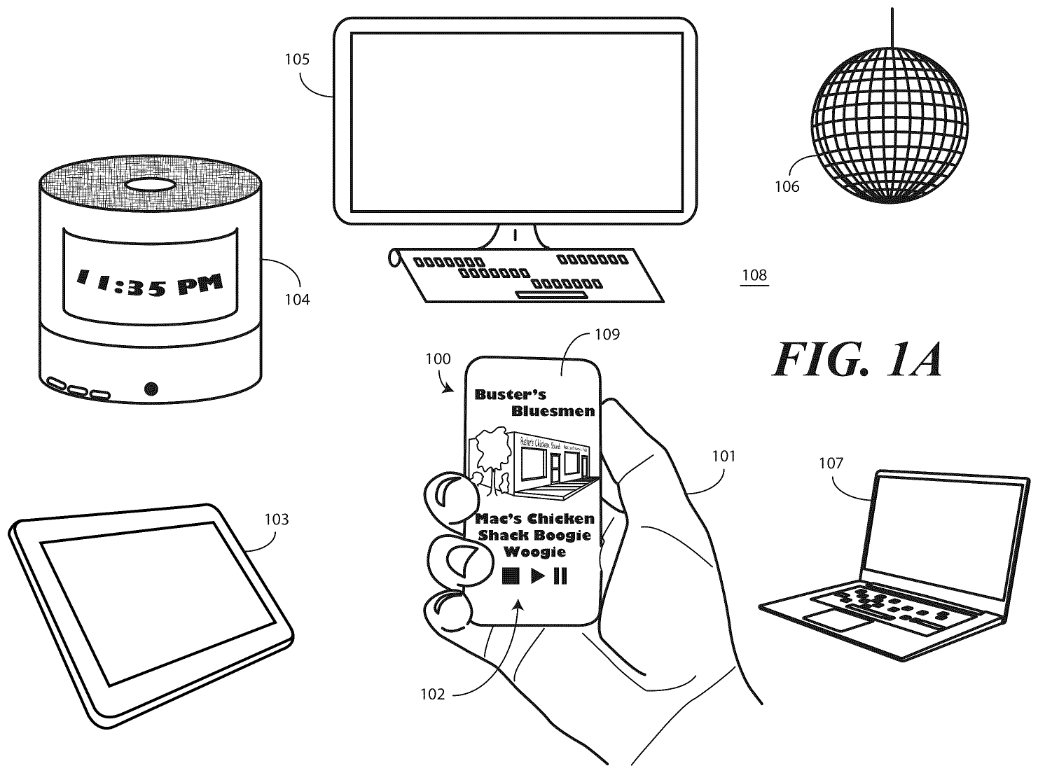

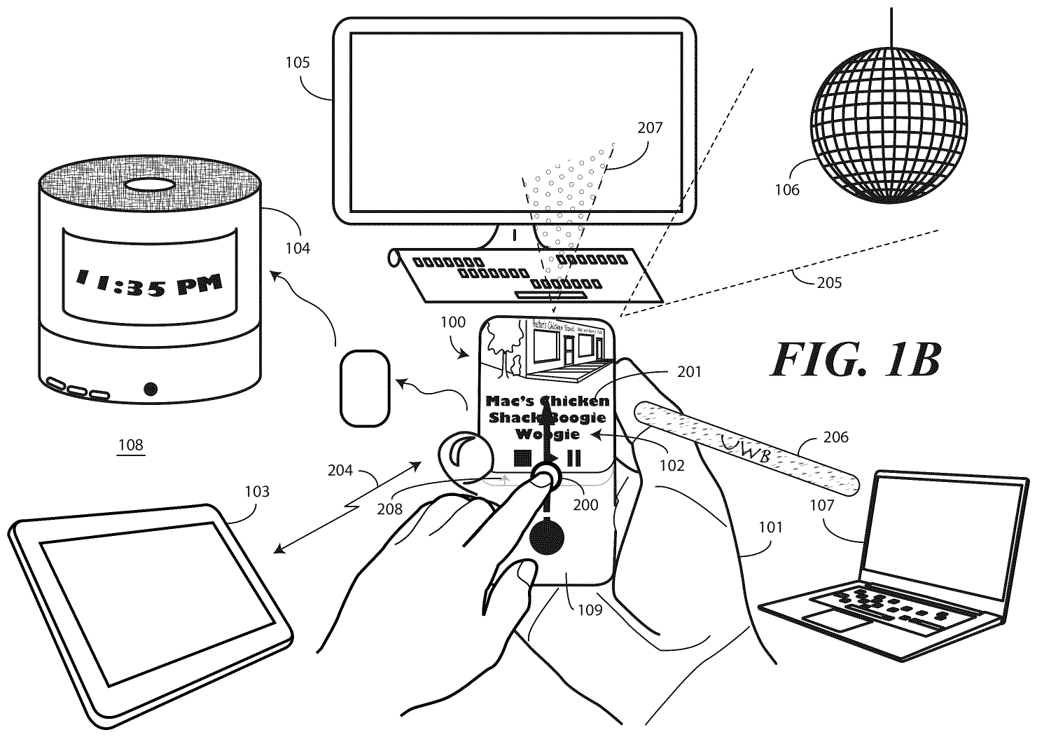

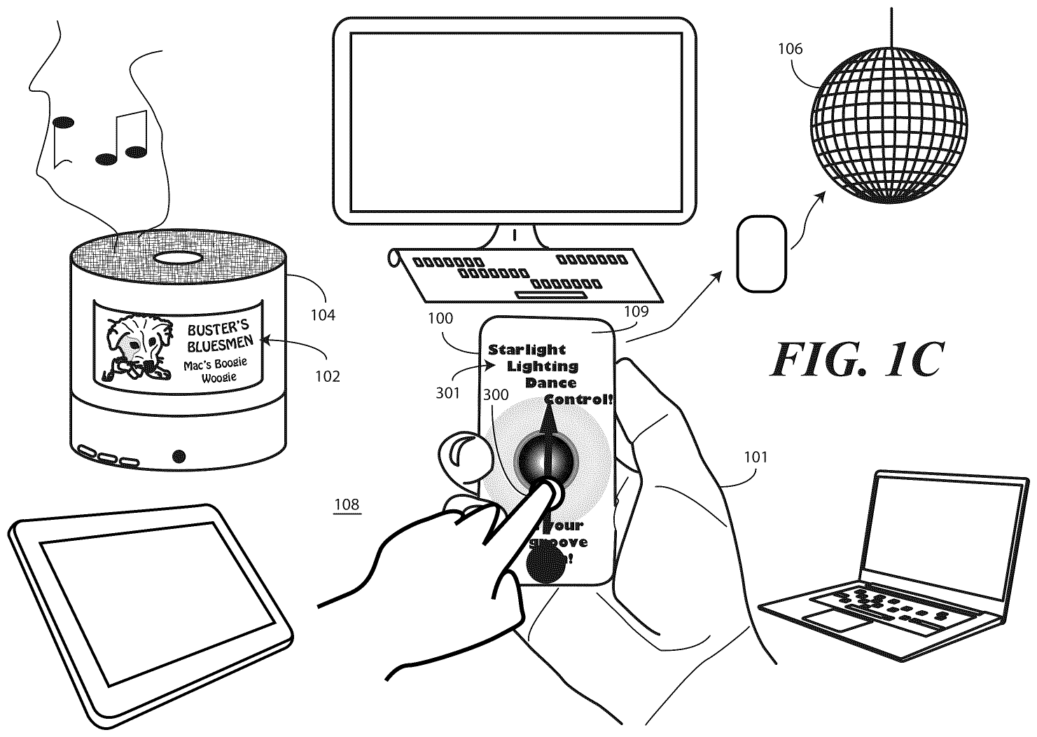

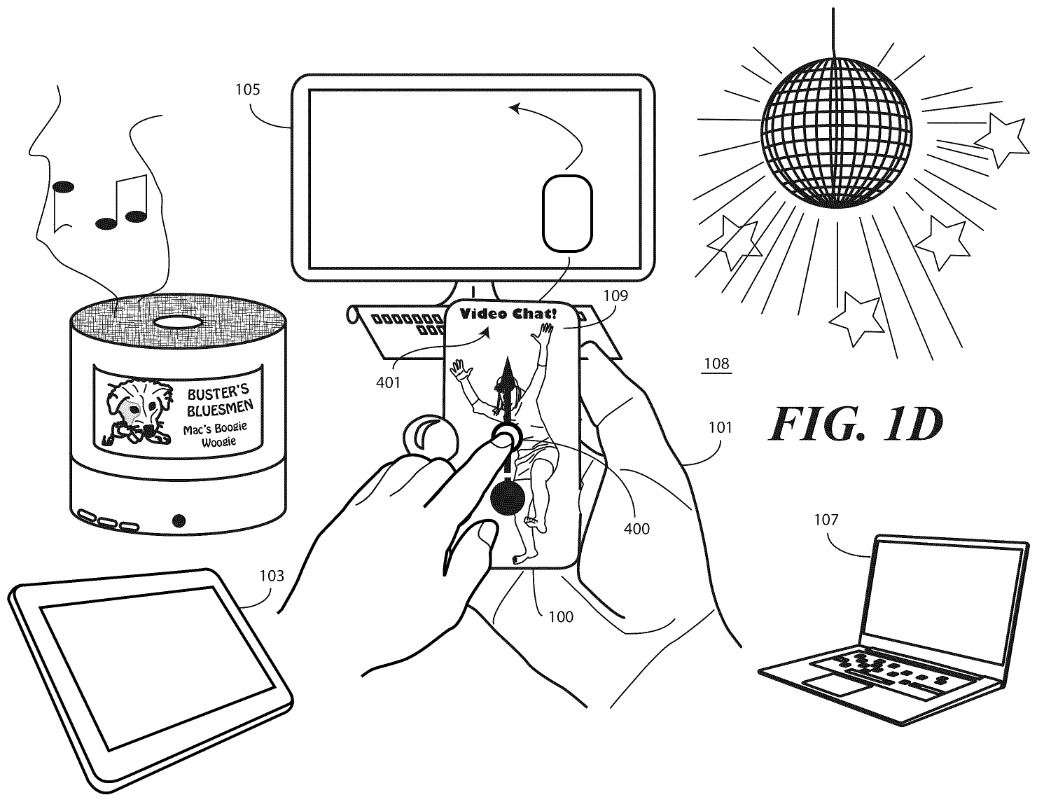

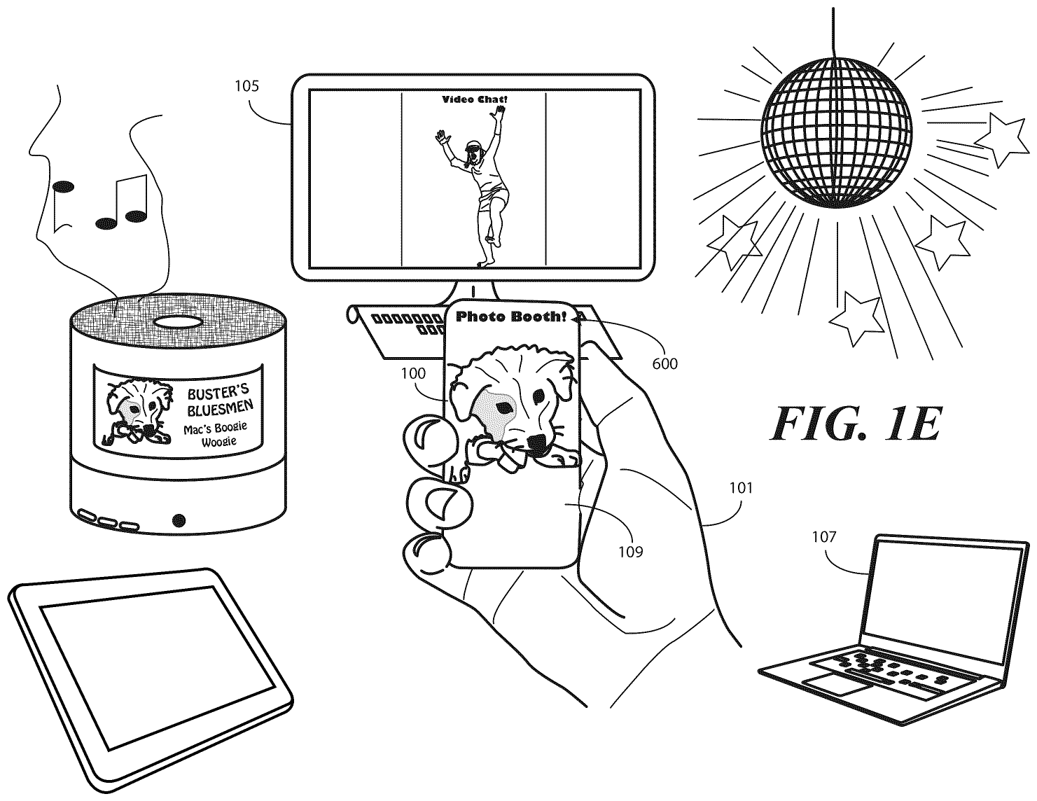

Turning now to FIG. 1A, illustrated therein is a user 101 using an electronic device 100 configured in accordance with one or more embodiments of the disclosure. As shown, a music player application 102 is operating as a foreground application in an application stack on the electronic device 100. To wit, the user 101 is listening to the iconic and legendary Buster and his Bluesmen play Mac's Chicken Shack Boogie Woogie.

While loving the reharmonizations of the basic blues form Buster employs, there are several companion electronic devices 103,104,105,106,107 operating within the environment 108 of the electronic device 100. These include companion electronic device 103, which is a tablet computer, companion electronic device 104, which is a music player, companion electronic device 105, which is a desktop computer, companion electronic device 106, which is a crazy disco ball, and companion electronic device 107, which is a laptop computer. Thus, companion electronic device 104, for example, would comprise one of a plurality of companion electronic devices 103,104,105,106,107 operating in the environment 108 of the electronic device 100.

The plurality of companion electronic devices 103,104,105,106,107 can communicate with the electronic device 100 in a variety of ways through a variety of networks and channels. Illustrating by example, in this illustrative embodiment companion electronic device 104 is a music player that is paired with the electronic device 100 by a Bluetooth™ connection. Companion device 106, the crazy disco ball, is communicating with the electronic device 100 through a router in a Wi-Fi network. Companion electronic device 105 is a computer that is a trusted device paired with the electronic device 100 through a peer-to-peer ad hoc network. It should be noted that these devices and communication techniques merely provide some examples of companion devices for illustration. Others will be readily apparent to those of ordinary skill in the art having the benefit of this disclosure.

Some of these companion electronic devices 103,104,105, 106,107 have better music rendering capabilities than the electronic device 100, while others are inferior to the electronic device 100. For instance, the music player has larger speakers with more powerful drivers than does electronic device 100, and thus is more suited for bringing out the sharp nines and flat thirteens of Buster's signature sound. By contrast, the crazy disco ball has no speakers and, despite having sophisticated electronics, would not do Buster justice in spreading the “blues gospel” he is laying down.

The user 101 in FIG. 1A does not want to interrupt the Mac's Chicken Shack Boogie Woogie—it is just too good a tune. In fact, you really do not listen Mac's Chicken Shack Boogie Woogie—you instead celebrate Mac's Chicken Shack Boogie Woogie. This celebration would be all the more enjoyable with better speakers. However, stopping Mac's Chicken Shack Boogie Woogie mid-tune would be no celebration indeed.

Fortunately, the electronic device 100 is configured in accordance with embodiments of the disclosure. This allows the user 101 to simply deliver a swipe gesture (or fling gesture) to the user interface 109 defined by the touch-sensitive display of the electronic device 100 to quickly and seamlessly transfer operation of the music player application from the electronic device 100 to another companion electronic device operating within the environment 108 that is identified by the swipe gesture.

In one or more embodiments, the one or more processors of the electronic device 100 are configured to select a particular companion electronic device from the plurality of companion electronic devices 103,104,105,106,107 operating within the environment 108 of the electronic device 100 as a function of at least one predefined criterion. Illustrating by example, in one or more embodiments the at least one predefined criterion comprises a proximity to, and orientation of the electronic device 100 in three-dimensional space relative to, the companion electronic device to which the user 101 wishes to transfer the music player application 102. Thus, if the user 101 wants to transfer the music player application 102 to the computer, he could stand near the computer, facing it, and deliver a swipe gesture or fling gesture to the user interface 109 of the electronic device 100. This proximity can be determined using an ultra-wideband ranging process, a Bluetooth™ channel sounding process, or other techniques.

However, in other embodiments, the at least one predefined criterion comprises a determination of which companion electronic device of the plurality of other companion electronic devices 103,104,105,106,107 is most optimized to operate the music player application 102. In this illustrative example, this would be the music player since it has speakers that are larger than the other companion electronic devices 103,105,106,107 and is specifically designed to play music. By contrast, if the foreground application had been a productivity application, such as a word processor or spreadsheet, the companion electronic device most optimized to operate the productivity application may be the computer. Similarly, of the foreground application had been a gaming application, the companion electronic device most optimized to operate the foreground application may be a companion electronic device that is operable by a gaming controller, while the companion electronic device most optimized to operate an audio/visual application may be a television, and so forth.

In this illustrative example, the user 101 simply wants to hear Mac's Chicken Shack Boogie Woogie using a higher fidelity system than that of the smartphone defining the electronic device 100 upon which the music player application 102 is operating in FIG. 1A. Advantageously, even if the user 101 does not know which companion electronic device that happens to be, in one or more embodiments the one or more processors of the electronic device 100 can determine this for the user 101. In this illustrative example, that best to operate companion electronic device is indeed the companion electronic device 104 defined by the music player given the fact that the music player has better speakers with which to celebrate the music.

Turning now to FIG. 1B, the user 101 does this by delivering a swipe gesture 200 (used for illustrative purposes but that could be replaced with a fling gesture as noted above) to the user interface 109 of the electronic device 100. Thus, as shown in FIG. 1B, the user interface 109 of the electronic device 100 receives the swipe gesture 200, which in this example occurs across a graphical user interface 201 of the music player application 102 while operating on the one or more processors of the electronic device 100. Additionally, the receipt of this swipe gesture 200 occurs while the plurality of companion electronic devices 103,104, 105,106, 107 are operating within the environment 108 of the electronic device 100.

In one or more embodiments, when this occurs the one or more processors of the electronic device 100 select a companion electronic device from the plurality of companion electronic devices 103,104,105,106,107 as a function of at least one predefined criterion. In this illustrative embodiment, the at least one predefined criterion comprises a determination of which companion electronic device of the plurality of companion electronic devices 103,104,105,106, 107 is most optimized to operate the music player application 102. Accordingly, the one or more processors select the companion electronic device 104 defined by the music player.

In one or more embodiments, one or more processors of the electronic device 100, using a communication device in response to the swipe gesture 200, transfer operation of the music player application 102, which is the foreground application operating on the one or more processors of the electronic device 100, to the companion electronic device 104 identified by the one or more processors. As shown in FIG. 1B, the swipe gesture 200 causes the music player application 102 to be transferred to the companion electronic device 104 defined by the music player.

In other embodiments where the at least one predefined criterion comprises a proximity to, and orientation of the electronic device 100 in three-dimensional space relative to a particular companion electronic device, the one or more processors of the electronic device 100 can determine, via electronic communications 204, optical detection 205, an ultra-wideband ranging process 206 to determine distances, angle of arrival measurements, or azimuth angles, a Bluetooth™ channel sounding process 207, or by other techniques, the locations of each of the plurality of companion electronic devices 103,104,105,106,107. Using these or other techniques, the one or more processors of the electronic device 100 can determine the location of the plurality of companion electronic devices 103,104,105,106,107 within the environment 108 relative to the electronic device 100.

Based upon this locational knowledge, in one or more embodiments the one or more processors of the electronic device 100 can determine to which companion electronic device the user 101 is closest and, optionally, to which companion electronic device the user 101 is facing. In one or more embodiments, this allows the one or more processors to cause the communication device of the electronic device 100 to transfer the music player application 102 to that closest, face-forward companion electronic device.

Another beneficial feature offered by embodiments of the disclosure shown in FIG. 1B is a visual depiction to the user 101 of what is occurring. In this illustrative embodiment, the application 102 being transferred is the music player application 102 that was operating as a foreground application operating on an application stack. As will be shown in FIG. 1C, in one or more embodiments when the foreground application is transferred to the companion electronic device 104, the one or more processors of the electronic device 100 can surface a penultimate application of the application stack on the user interface 109 as a new foreground application.

Regardless of whether the music player application 102 is a foreground application on an application stack or a singular application operating on the one or more processors of the electronic device 100, in one or more embodiments to provide a visual cue that the application 102 is being transferred to the companion electronic device 104 the one or more processors cause an animation 208 of a graphical user interface 201 of the music player application 102 to move on the user interface 109, appearing to move off the user interface 109, while the communication device transfers the operation of the application operating on the one or more processors to the companion electronic device 104 selected as a function of the at least one predefined criterion. In this illustrative example, this makes the graphical user interface 201 look like its flying from the display of the electronic device 100 off the electronic device 100.

Turning now to FIG. 1C, operation of the music player application 102 has been fully transferred to companion electronic device 104. Since the music player application 102 was a foreground application of an application stack when operating on the electronic device 100, the one or more processors of the electronic device surface a penultimate application 301, which is a lighting control application for the crazy disco ball, to operate as a new foreground application on the application stack.

Once again, the user 101 desires to transfer the lighting control application to a companion electronic device 106 operating within the environment 108 of the electronic device 100. Since the electronic device 100 is configured to select the companion electronic device most optimized to operate the lighting control application, in response to a swipe gesture the one or more processors will select the crazy disco ball. Accordingly, the user 101 delivers another swipe gesture 300 across a surface of the user interface 109. As previously described, this causes the communication device of the electronic device 100 to transfer operation of the lighting control application to the crazy disco ball in response to the swipe gesture 300.

Turning now to FIG. 1D, this transfer causes the crazy disco ball to be controlled by the lighting application, thereby emitting light and spinning. Since the lighting control application, prior to transfer, was the foreground application of the application stack in the electronic device 100, the one or more processors of the electronic device have again surfaced a penultimate application 401 from before the transfer to operate as a foreground application of the application stack after the transfer.

In this illustrative embodiment, the penultimate application 401 is a video chat application. There are three possible companion electronic devices 103,105,107 operating within the environment 108 of the electronic device 100 that are capable of operating the video chat application.

Given that this is the case, in this illustrative embodiment, to confirm that the user 101 wishes to transfer the video chat application to the companion electronic device 105 defined by the computer, and not companion electronic device 103 or companion electronic device 107, the user has moved closer to companion electronic device 105 and is facing companion electronic device 105. Accordingly, when another swipe gesture 400 is delivered to the user interface 109, in addition to the fact that companion electronic device 105 is optimized to present the video chat application, the one or more processors of the electronic device 100 are able to confirm the users intent, by detecting proximity of, and orientation of the electronic device and three-dimensional space relative to, companion electronic device 105. As such, the one more processors of the electronic device 100 cause the communication device of the electronic device 100 to transfer the video chat application to companion electronic device 105.

Turning now to FIG. 1E, this causes the video chat application to start operating on companion electronic device 105. It also causes the previous penultimate application, which is a photo booth application, to surface as the foreground application on the user interface 109 of the electronic device 100. Should the user 101 wish to transfer this penultimate application, shown now as the foreground application, to a device with a better display, e.g., companion electronic device 107, the user 101 could do this by delivering another swipe gesture while companion electronic device 107 is operating in the environment 108 of the electronic device 100. In response to the swipe gesture, the one or more processors of the electronic device 100 would then cause a communication device to transfer operation of this now foreground application of the application stack to the companion electronic device 105 upon selecting companion electronic device 107 as a function of at least one predefined criterion. The one or more processors could then surface another penultimate application of the application stack as a new foreground application as previously described.

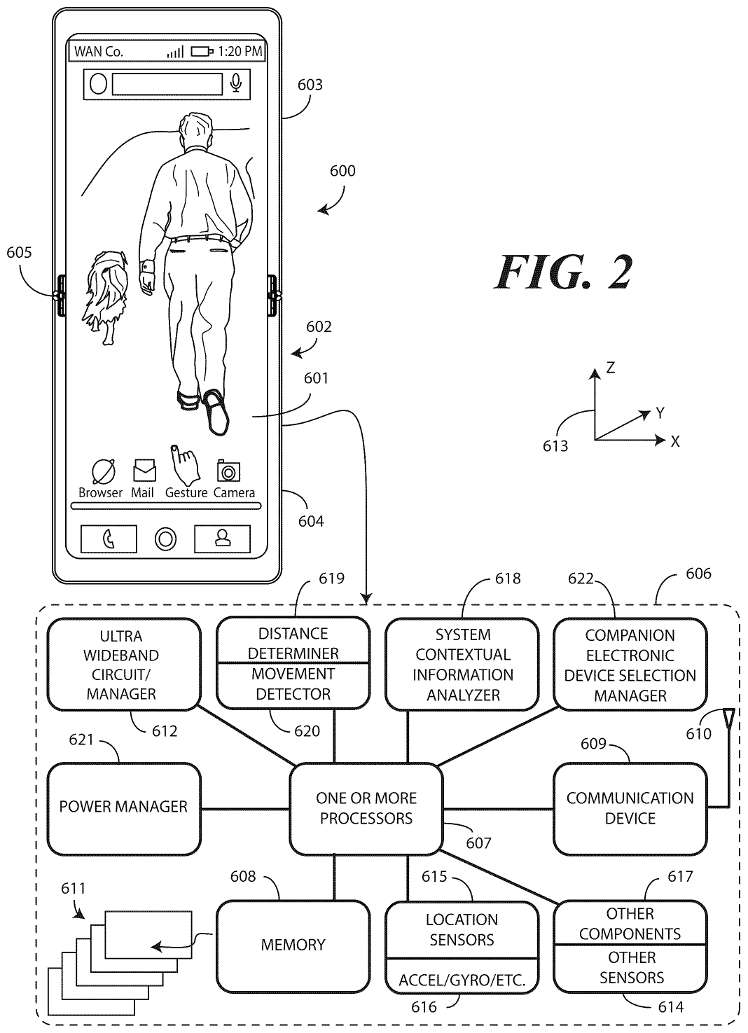

Turning now to FIG. 2, illustrated therein is one explanatory electronic device configured in accordance with one or more embodiments of the disclosure. The electronic device 600 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 600 could equally be a conventional desktop computer, palm-top computer, a tablet computer, a gaming device, a media player, or other device.

This illustrative electronic device 600 includes a display 601, which may optionally be touch-sensitive. Users can deliver user input to the display 601, which serves as a user interface for the electronic device 600. In one embodiment, users can deliver user input to the display 601 of such an embodiment by delivering touch input from a finger, stylus, or other objects disposed proximately with the display 601. In one embodiment, the display 601 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 600 of FIG. 2 also includes a device housing 602. In one embodiment, the device housing 602 includes two housing members, namely, a first device housing 603 that is coupled to a second device housing 604 by a hinge 605 such that the first device housing 603 is pivotable about the hinge 605 relative to the second device housing 604 between a closed position and an axially displaced open position. In other embodiments, such as that associated with the electronic device (100) of FIGS. 1A-1E, the device housing 602 will be rigid and will include no hinge.

In still other embodiments, the device housing 602 will be manufactured from a flexible material such that it can be bent and deformed. Where the device housing 602 is manufactured from a flexible material or where the device housing 602 includes a hinge, the display 601 can be manufactured on a flexible substrate such that it bends. In one or more embodiments, the display 601 is configured as a flexible display that is coupled to the first device housing 603 and the second device housing 604, spanning the hinge 605. Features can be incorporated into the device housing 602, including control devices, connectors, and so forth.

Also shown in FIG. 2 is an explanatory block diagram schematic 606 of the explanatory electronic device 600. In one or more embodiments, the block diagram schematic 606 is configured as a printed circuit board assembly disposed within the device housing 602 of the electronic device 600. Various components can be electrically coupled together by conductors, or a bus disposed along one or more printed circuit boards.

The illustrative block diagram schematic 606 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 607. In one embodiment, the one or more processors 607 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 606. Each of the application processor and the auxiliary processor(s) can be configured to process and execute executable software code to perform the various functions of the electronic device with which the block diagram schematic 606 operates. A storage device, such as memory 608, can optionally store the executable software code used by the one or more processors 607 during operation.

In this illustrative embodiment, the block diagram schematic 606 also includes a communication device 609 that can be configured for wired or wireless communication with one or more other devices or networks. The networks can include a wide area network, a local area network, and/or personal area network. The communication device 609 may also utilize wireless technology for communication, such as, but are not limited to, peer-to-peer or ad hoc communications such as HomeRF, Bluetooth™ (suitable for performing the Bluetooth™ channel sounding process (207) described above with reference to FIG. 1B), IEEE 802.11, and other forms of wireless communication such as infrared technology. The communication device 609 can include wireless communication circuitry, one of a receiver, a transmitter, or transceiver, and one or more antennas 610.

In one embodiment, the one or more processors 607 can be responsible for performing the primary functions of the electronic device with which the block diagram schematic 606 is operational. For example, in one embodiment the one or more processors 607 comprise one or more circuits operable with the display 601 to present presentation information to a user. The executable software code used by the one or more processors 607 can be configured as one or more modules 611 that are operable with the one or more processors 607. Such modules 611 can store instructions, control algorithms, and so forth.

In one or more embodiments, the block diagram schematic 606 includes an ultra-wideband component 612, which is suitable for performing the ultra-wideband ranging process (206) described above with reference to FIG. 1B. In one or more embodiments, the ultra-wideband component 612 is similar to the communication device 609 in that it is configured to perform wireless communications with one or more other ultra-wideband components that may be integrated into, or attached to, other devices.

The illustrative ultra-wideband component 612 of FIG. 2 is a dedicated ultra-wideband transceiver constructed into the electronic device 600 configured to use the one or more antennas 610 or its own antenna structure to communicate, using ultra-wideband technology, with another ultra-wideband component situated in another electronic device, examples of which include the companion electronic devices (103,104,105,106, 107) of FIGS. 1A-1E. In one or more embodiments, the ultra-wideband component 612 comprises wireless communication circuitry, one of a receiver, a transmitter, or transceiver, and one or more antennas, which may be separate from, or the same as, the one or more antennas 610 used by the communication device 609.

The inclusion of an ultra-wideband component 612 advantageously allows wireless communication with another ultra-wideband component connected to or integrated into another electronic device that is fast and secure, all while requiring very little power. In one or more embodiments, the ultra-wideband component 612 consumes at least an order of magnitude less energy than does the communication device 609. Ultra-wideband communication is especially well suited to embodiments of the disclosure because it is configured for short-range (within 250 meters) communication, which is well beyond the typical distance that will occur when an electronic device such as the electronic device 600 of FIG. 2 is operating within the environment (108) of FIGS. 1A-1E with the other companion electronic devices (103,104,105,106,107).

Additionally, the accuracy of location, and therefore the accuracy of distance measurements, is within a centimeter or less. While a Bluetooth™ channel sounding process can also be used to determine the location of companion electronic devices (103,104, 105, 106, 107) operating within the environment (108), the use of an ultra-wideband ranging process (206) can be preferred because Bluetooth™ has an accuracy range of between one and five meters. Other location determination techniques, such as Wi-Fi, can be used as well but only have an accuracy of five to fifteen meters.

Ultra-wideband is also quite reliable, in that it offers strong immunity to multi-path communication channels and interference in the line of sight. It also offers exceptional bandwidth, with data communications occurring at up to 27 Mbps, which is in contrast to the 2 Mbps provided by Bluetooth™ Ultra-wideband is also very low latency, with typically latencies being less than a millisecond, which is in contrast to the several seconds of latency that can occur with Bluetooth™.

In one or more embodiments, the ultra-wideband component 612 can also be used to measure angle of arrival. Effectively, when the one or more antennas 610 are configured as an antenna array, the ultra-wideband component 612 can compare signals received from one side of the antenna array with other signals received from another side of the antenna array to determine an orientation of the electronic device 600 in three-dimensional space 613 relative to a content presentation companion device having another ultra-wideband component attached thereto or integrated therein.

Thus, angle of arrival measures the phase difference between two receive antennas of an antenna array to determine the amount of relative angle offset between the antenna array and a source of the signals. If two devices are situated normal to each other, then the angle of arrival would be either zero or very small. Additionally, this angle of arrival is independent of distance. The angle of arrival measurement is capable of measuring where the electronic device 600 is in relation to another electronic device from which phase differentiated signals are received in terms of elevation and azimuth as well.

To illustrate the independence of distance, if the electronic device 600 is situated normal to another electronic device with an angle of arrival that is zero, this angle of arrival remains zero when the electronic device 600 moves toward, or away from, the other electronic device (without rotating and staying on the same trajectory). It should be noted that an angle of arrival measurement can also measure how parallel the plane of the electronic device 600 and the ultra-wideband antenna array of the other electronic device are arranged (when on bore sight for the two antennas). Again, a zero angle of arrival would mean the two antenna arrays are perfectly parallel and perpendicular to each other. Again, in most situations angle of arrival is relatively independent of distance.

Various sensors 614 can be operable with the one or more processors 607. One example of a sensor that can be included with the various sensors 614 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 607, to detect an object in close proximity with—or touching—the surface of the display 601 or the device housing 602 of the electronic device 600 by establishing electric field lines between pairs of capacitive sensors and then detecting perturbations of those field lines.

Another example of a sensor that can be included with the various sensors 614 is a geo-locator that serves as a location detector 615. In one embodiment, location detector 615 is able to determine location data, both of the electronic device 600 itself and of companion electronic devices situated within an environment of the electronic device 600. In one or more embodiments. The location detector 615 determines the locations of companion electronic devices operating within an environment of the electronic device 600 from electronic communications from location detectors operating in those companion electronic devices via the communication device 609.

Location of the electronic device 600 can be determined by capturing the location data from a constellation of one or more earth orbiting satellites, or from a network of terrestrial base stations to determine an approximate location. The location detector 615 may also be able to determine location by locating or triangulating terrestrial base stations of a traditional cellular network, or from other local area networks, such as Wi-Fi networks.

Another example of a sensor that can be included with the various sensors 614 is an orientation detector 616 operable to determine an orientation and/or movement of the electronic device 600 in three-dimensional space 613. Illustrating by example, the orientation detector 616 can include an accelerometer, gyroscopes, or other device to detect device orientation and/or motion of the electronic device 600. Using an accelerometer as an example, an accelerometer can be included to detect motion of the electronic device. Additionally, the accelerometer can be used to sense some of the gestures of the user, such as one talking with their hands, running, or walking.

The orientation detector 616 can determine the spatial orientation of an electronic device 600 in three-dimensional space 613 by, for example, detecting a gravitational direction. In addition to, or instead of, an accelerometer, an electronic compass can be included to detect the spatial orientation of the electronic device 600 relative to the earth's magnetic field. Similarly, one or more gyroscopes can be included to detect rotational orientation of the electronic device 600.

Other components 617 operable with the one or more processors 607 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 617 can also include proximity sensors, which can also be used to determine the location of companion electronic devices operating within an environment of the electronic device 600. The proximity sensors generally fall in to one of two camps: active proximity sensors and “passive” proximity sensors. Either the proximity detector components or the proximity sensor components can be generally used for gesture control and other user interface protocols.

The other components 617 can optionally include a barometer operable to sense changes in air pressure due to elevation changes or differing pressures of the electronic device 600. The other components 617 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 600. Similarly, a temperature sensor can be configured to monitor temperature about an electronic device.

A context engine 618 can then be operable with the various sensors to detect, infer, capture, and otherwise determine persons and actions that are occurring in an environment about the electronic device 600. For example, where included one embodiment of the context engine 618 determines assessed contexts and frameworks using adjustable algorithms of context assessment employing information, data, and events.

These assessments may be learned through repetitive data analysis. Alternatively, a user may employ a menu or user controls via the display 601 to enter various parameters, constructs, rules, and/or paradigms that instruct or otherwise guide the context engine 618 in detecting multi-modal social cues, emotional states, moods, and other contextual information. The context engine 618 can comprise an artificial neural network or other similar technology in one or more embodiments.

In one or more embodiments, the electronic device 600 includes a distance determination manager 619 that is operable with the ultra-wideband component 612 to determine a precise distance (within one centimeter) of the electronic device 600 in relation to other electronic devices also having ultra-wideband components or ultra-wideband tags (the difference between a ultra-wideband component and a ultra-wideband tag is that the ultra-wideband component is integrated into an electronic device as an original component, while a ultra-wideband tag is a self-contained ultra-wideband component that can be attached to an electronic device as a retrofit item to configure a legacy electronic device to communicate via ultra-wideband technology).

A motion detector 620 determines when the electronic device 600 moves. A power manager 621 can be configured to ensure that distance measurements, ultra-wideband communications, Bluetooth™ communications, user interactions such as the receipt of swipe gestures and their directional vectors, and other operations are optimally performed with minimal power expenditures.

In one or more embodiments, the electronic device 600 includes a companion electronic device selection manager 622. In one or more embodiments, the companion electronic device selection manager 622 is configured, at a high level, to select a companion electronic device operating in an environment of the electronic device 600 to which an application operating on the one or more processors 607 should be transferred in response to a swipe gesture or, alternatively, a fling gesture if the electronic device 600 is so configured. In one or more embodiments, the companion electronic device selection manager 622 can make this selection as a function of at least one predefined criterion. Examples of such predefined criteria include a proximity to, and orientation of the electronic device 600 in three-dimensional space 613 relative to, a particular companion electronic device, a determination of which companion electronic device of the plurality of companion electronic devices operating within the environment of the electronic device 60 is most optimized to operate the application, a usage history of the application, such as to which companion electronic device operation of the application has been transferred in the past, the time of day at which the application was transferred from the electronic device 600 to the selected companion electronic device in the past, or other factors.

In some embodiments, the companion electronic device selection manager 622 is configured to prioritize the plurality of companion electronic devices as a function of these or other criteria. Thereafter, the companion electronic device selection manager 622 can select a particular companion electronic device as a result of this prioritization. Said differently, in one or more embodiments the companion electronic device selection manager 622 is configured to prioritize a plurality of companion electronic devices as a function of at least one predefined criterion to select a companion electronic device from the plurality of companion electronic devices.

Thereafter, the one or more processors 607 can cause the communication device 609 to transfer operation of a foreground application operating on the one or more processors to the companion electronic device selected. Should a user of the electronic device 600 desire for the operation of the application to return to the electronic device 600, the one or more processors 607 can further cause the communication device 609 to recall the operation of the foreground application from the companion electronic device in response to the user interface receiving another gesture input, examples of which include a tap, a double-tap, a swipe down gesture, or other gesture.

The companion electronic device selection manager 622, which can be operable with the one or more processors 607 and can receive data from the various sensors 614, selects a particular electronic device from the plurality of electronic devices operating within the environment of the electronic device. In some embodiments, the one or more processors 607 can control the companion electronic device selection manager 622. In other embodiments, the companion electronic device selection manager 622 can operate independently from the one or more processors 607. In one or more embodiments, the one or more processors 607 are configured to perform the operations of the companion electronic device selection manager 622.

Illustrating by example, in one or more embodiments one or more processors 607 of the electronic device 600 evaluate, in response to a user interface receiving a swipe gesture or fling gesture, a user's direction using an ultra-wideband ranging process performed by the ultra-wideband component 612 based upon angle of arrival. From this information, the one or more processors can select a companion electronic device to which an application operating on the one or more processors 607 should be transferred. The one or more processors 607 can then transfer, using the communication device 609 of the electronic device 600, operation of the application to the companion electronic device selected.

In other embodiments, the companion electronic device selection manager 622 may select the companion electronic device to which the application is to be transferred using the category of applications to which the application is associated. If, for example, the application to be transferred is a productivity application, such as a word processing document or a spreadsheet, the companion electronic device selection manager 622 may select a computer to transfer the application to in response to a swipe gesture or fling gesture since such a computer is likely to have a mouse or other user controls suitable for navigating such an application. By contrast, if the application to be transferred is a video streaming application or an entertainment application, the companion electronic device selection manager 622 may select a television for transfer in response to a swipe gesture or fling gesture. If the application to be transferred is a gaming application, the companion electronic device selection manager 622 may select to transfer the application to a device having a gaming controller attached thereto in response to a swipe gesture or fling gesture, and so forth.

In still other embodiments, selection of the companion electronic device to which transfer of an application in response to a swipe gesture or fling gesture will occur can be based upon past usage of the application. In one or more embodiments, the companion electronic device selection manager 622 can select a companion electronic device to which the application will be transferred based upon machine learning that the application has operated on a particular device at a particular time of day or particular day of the week. Of course, these factors can be used in alone or in combination.

Thus, in one or more embodiments the companion electronic device selection manager 622 selects a companion electronic device from a plurality of companion electronic devices operating in an environment of the electronic device 600 as a function of a selection criterion, examples of which include proximity to, and orientation of the electronic device relative to, a companion electronic device, which companion electronic device of the plurality of companion electronic devices is optimized to operate the application, or a transfer history of the application from the electronic device 600. Other selection criteria will be obvious to those of ordinary skill in the art having the benefit of this disclosure. After transfer, the one or more processors 607 can also surface the operation of a penultimate application of the application stack as a new foreground application after the transfer, as previously described.

The electronic device 600 can also include a distance determination manager 619 that is operable with the companion electronic device selection manager 622, the communication device 609, and/or the ultra-wideband component 612. Illustrating by example, in one or more embodiments the ultra-wideband component 612, using ultra-wideband ranging process, delivers signals to the distance determination manager 619. The distance determination manager 619 can then use distance to identify a companion electronic device, as it is unlikely that every companion electronic device of the plurality of companion electronic devices operating within the environment will be the same distance from the electronic device 600. When combined with the orientation of the electronic device 600 relative to a particular companion electronic device determined by the companion electronic device selection manager 622, selection of a companion electronic device operating within the environment of the electronic device 600 can be made with precision.

In one or more embodiments, motion detectors 620 carried by the electronic device 600 can determine when the electronic device 600 moves relative to the various companion electronic devices operating within the environment. When this occurs, companion electronic device selection manager 622 and/or the distance determination manager 619 can repeat their calculations to ensure that the locations of the companion electronic devices operating in the environment is continuously known to the one or more processors 607 despite the electronic device 600 moving around within that environment.

In one or more embodiments, the ultra-wideband component 612 can also perform an ultra-wideband angle of arrival measurement to determine an orientation of the electronic device 600 in three-dimensional space 613 relative to the content presentation companion device. Illustrating by example, the ultra-wideband angle of arrival measurement can be used to determine whether a person holding an electronic device 600, while delivering a swipe gesture to the display 601, is facing a particular companion electronic device or is facing away from a particular companion electronic device.

It is to be understood that FIG. 2 is provided for illustrative purposes only and for illustrating components of one electronic device 600 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure. In other embodiments, these support plates will be omitted.

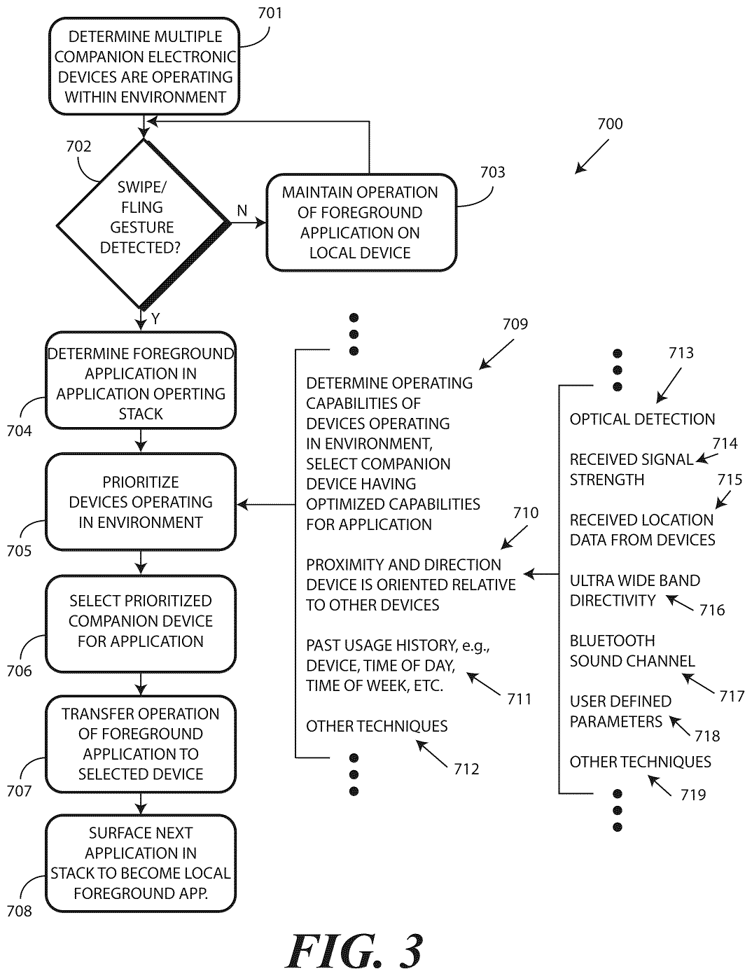

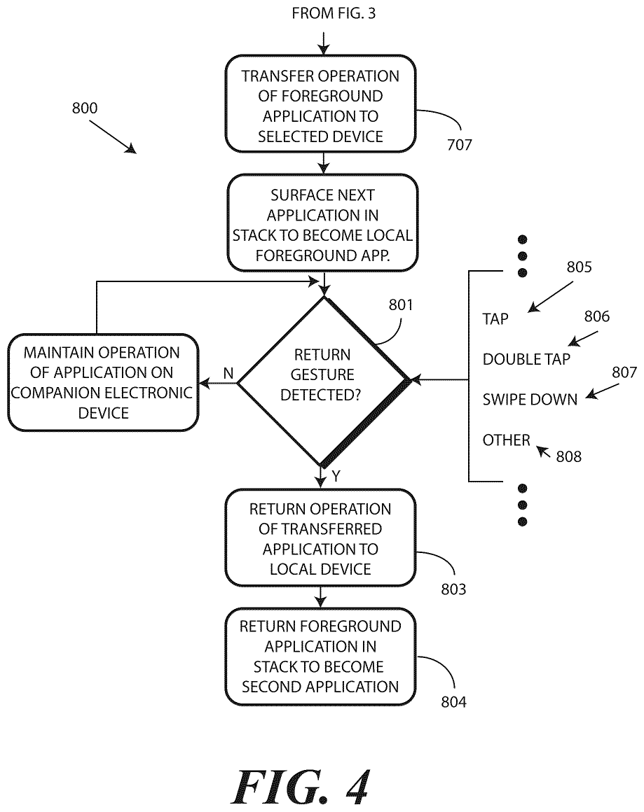

Turning now to FIG. 3, illustrated therein is one explanatory method 700 for an electronic device. The method 700 of FIG. 3 is suitable for use in the electronic device (600) of FIG. 2, the electronic device (100) of FIGS. 1A-1E, or another electronic device.

Beginning at step 701, one or more processors of an electronic device determine that multiple companion electronic devices are operating within an environment of the electronic device. This can be done in a variety of ways, including by detecting electronic communications received from the companion electronic devices via peer-to-peer, Wi-Fi, cellular, or other networks. Additionally, an ultra-wideband component, proximity censors, image capture devices via image analysis, or other sensors of the electronic device can detect that a plurality of companion electronic devices are operating in the environment of the electronic device as well. In one or more embodiments, step 701 determines the locations of each companion electronic device as well, as described above.

Decision 702 determines whether a swipe gesture (or alternatively a fling gesture) is received by a user interface of the electronic device. Where it is, the method 700 moves to step 704 where one or more processors of the electronic device can also identify a foreground application operating on the one or more processors. In one or more embodiments, this foreground application will be the foreground application of an application stack. Otherwise, step 703 maintains operation of the foreground application on the one or more processors of the electronic device.

Step 705 then comprises prioritizing the plurality of companion electronic devices identified at step 701 as a function of at least one predefined criterion. As shown in FIG. 3, the at least one predefined criterion can take various forms.

In one or more embodiments, the at least one predefined criterion comprises a determination 709 of which companion electronic device is optimized to perform the foreground application identified at step 704. Illustrating by example, if the foreground application comprises a music player application, a prioritized companion electronic device may comprise a music player. If the foreground application comprises a productivity application, the highest prioritized companion electronic device may be a computer. If the foreground application comprises a gaming application, the top of the prioritized stack may be a companion electronic device operable by a gaming controller. If the foreground application is an audio/visual application, the companion electronic device that is most highly prioritized may be a television, and so forth.

The prioritization performed at step 705 can include less optimized electronic devices as well. For instance, if the foreground application is an audio/visual application and the highest priority device is a television, but that television is currently being used by a user, the next most optimized companion electronic device may be a computer with a large display as a candidate for selection due to the operation of the top selection being in use.

In other embodiments, the at least one predefined criterion comprises a proximity 710 to, and orientation of, the electronic device in three-dimensional space relative to the companion electronic device. This can be determined in a variety of ways.

Illustrating by example, in one or more embodiments an image capture device employs optical detection 713 using image analysis to determine the locations of each companion electronic device. Similarly, a communication device of the electronic device can use received signal strength measurements 714 to determine locations of the various companion electronic devices.

In some embodiments, each companion electronic device will transmit its location data 715 to alert the one or more processors of the electronic device as to where each companion electronic device is situated in three-dimensional space. By comparing this location data 715 to the location data of the electronic device determined by its own location detector, precise locations of each companion electronic device can be determined.

In other embodiments, an ultra-wideband ranging process 716 can determine the location of each companion electronic device with precision as described above. Similarly, Bluetooth™ channel sounding 717 can be used. In some simpler embodiments, a user can simply enter the locations of the companion electronic devices with user input 718 delivered to the user interface. Other techniques 719 for determining the location of the various companion electronic devices will be obvious to those of ordinary skill in the art having the benefit of this disclosure.

In still other embodiments, the at least one predefined criterion can comprise a usage history 711 of the foreground application. In one or more embodiments, the usage history 711 is defined by a selected companion electronic device to which the operation of the foreground application has been transferred in the past. In one or more embodiments, the usage history 711 is further defined by a time of day at which the operation of the application was transferred from the electronic device to a selected companion electronic device in the past. The time of the week, time of the month, season, holidays, or other information can be factored into the usage history 711 as well. Additionally, other techniques 712 for determining the predefined criterion, such as user profiles, battery life remaining, processor bandwidth, user-defined settings, capabilities of the transferring device, e.g., display size, speaker size, speaker output power, and so forth, and foreground application category can be used as the predefined criterion. Other examples will be obvious to those of ordinary skill in the art having the benefit of this disclosure.

At step 706, one or more processors of the electronic device select a companion electronic device from the plurality of companion electronic devices operating in the environment of the electronic device as a function of a selection criterion. In one or more embodiments, the selection criterion comprises one of proximity to, and orientation of the electronic device relative to, the companion electronic device, which companion electronic device of the plurality of companion electronic devices is optimized to operate the application, or a transfer history of the application from the electronic device.

In response to the swipe or fling gesture detected at decision 702, step 707 transfers the foreground application to the companion electronic device selected at step 706. This transfer occurring at step 707 can vary.

Illustrating by example, in a situation where a user is sitting at his desk with his smartphone lying flat on the desk next to his computer, step 707 can transfer the foreground application to the computer to make it easier to interact with this information on the screen of his computer. This would be a complete transfer of the foreground application to the companion electronic device. However, other types of transfers can occur at step 707 in other embodiments.

For instance, the transfer occurring at step 707 can perform “drag and drop” operations. In one or more embodiments, a user may deliver a directional swipe gesture to cause, for example, photos depicted on the display of his smartphone to slide over to a larger display that is visible to the friend. This transfers content output by the application to the companion electronic device without transferring underlying operational control of the application to the companion electronic device.

In still other embodiments, a user can use a swipe gesture to transfer the content rendering application component to a companion electronic device. Embodiments of the disclosure contemplate that the transfer of this rendering component can be independent of other components of the application. Thus, in one or more embodiments the content generating application component of the venue viewing application can remain operational on the electronic device while the content rendering application component is transferred to the companion electronic device.

In effect, the application's content generating (i.e., processor intensive) components are running on the electronic device while the displaying components (which use less processing power) are running on the companion electronic device. Of course, the opposite transfer could occur to offload processor-intensive components of an application as well.

In other, more equitable situations, embodiments of the disclosure contemplate that the swipe gesture can lead to the transfer of a second instance of a foreground application from a first device to a second device at step 707. Illustrating by example, in other embodiments the electronic device may transfer an instance of a foreground application to a companion electronic device so that multiple users can both interact with the application independently. In such a situation, embodiments of the disclosure contemplate that the electronic device may be hosting two instances of the same application, with a content rendering application component and navigation application component of one instance being operational on a companion electronic device.

In one or more embodiments, step 707 comprises causing, by one or more processors using a communication device, operation of a foreground application of an application stack to be transferred to the companion electronic device selected at step 706. As noted above, step 707 may optionally animate movement of a graphical user interface of the foreground application out of the application stack during the transfer to provide a visual indicator to the user that operation is being transferred from one electronic device to another.

Other operations can be performed as well at step 707, including providing haptic feedback to a user when the transfer is complete, e.g., by vibrating the electronic device, by providing additional animations such as bubbling and expansion on the receiving device, and so forth. Still other additional operations will be obvious to those of ordinary skill in the art having the benefit of this disclosure.

Optionally, step 708 can then surface operation of a penultimate application of the application stack as a new foreground application after the transfer. Advantageously, the method 700 of FIG. 3 provides electronic devices and corresponding methods that allow a user to effortlessly transition a mobile application from one smartphone to another. In one or more embodiments, this occurs with a continuity of media rendering with no stoppage or restarting of the application being transferred required. This advantageously allows a user to transfer applications from one device to another without any user experience “friction.” Moreover, it allows the user to maintain their experience immersion since the content keeps on playing with no need to pause, stop, or restart.

While the method 700 of FIG. 3 transfers an application, embodiments of the disclosure also contemplate that a user may desire to recall the application to the electronic device at a later time. Turning now to FIG. 4, illustrated therein is one explanatory method 800 for doing so. Others will be obvious to those of ordinary skill in the art having the benefit of this disclosure.

The method 800 begins with step 707, where one or more processors transfer, using a communication device in response to a swipe gesture, operation of an application operating on the one or more processors to the communication device selected as a function of a selection criterion or at least one predefined criterion. Decision 801 then determines whether a predefined gesture requesting return of the operation of the application is desired.

The predefined gesture detected at decision 801 can vary. In one or more embodiments, the predefined gesture comprises a tap gesture 805 on the user interface of the electronic device. In other embodiments, the predefined gesture comprises a double-tap gesture 806.

In still other embodiments, the predefined gesture identifies the companion electronic device from which the operation of the application should be withdrawn. Illustrating by example, in one or more embodiments the predefined gesture comprises a swipe down gesture 807 will function as a recall gesture. Other examples 808 will be obvious to those of ordinary skill in the art having the benefit of this disclosure.

At step 803, the method 800 recalls the operation of the application from the companion electronic device. In one or more embodiments, step 803 also resumes the operation of the application on the one or more processors of the electronic device. Where the application was one application of an application stack, step 804 can return the application to be the foreground application of the application stack, relegating the previous foreground application to become a penultimate application.

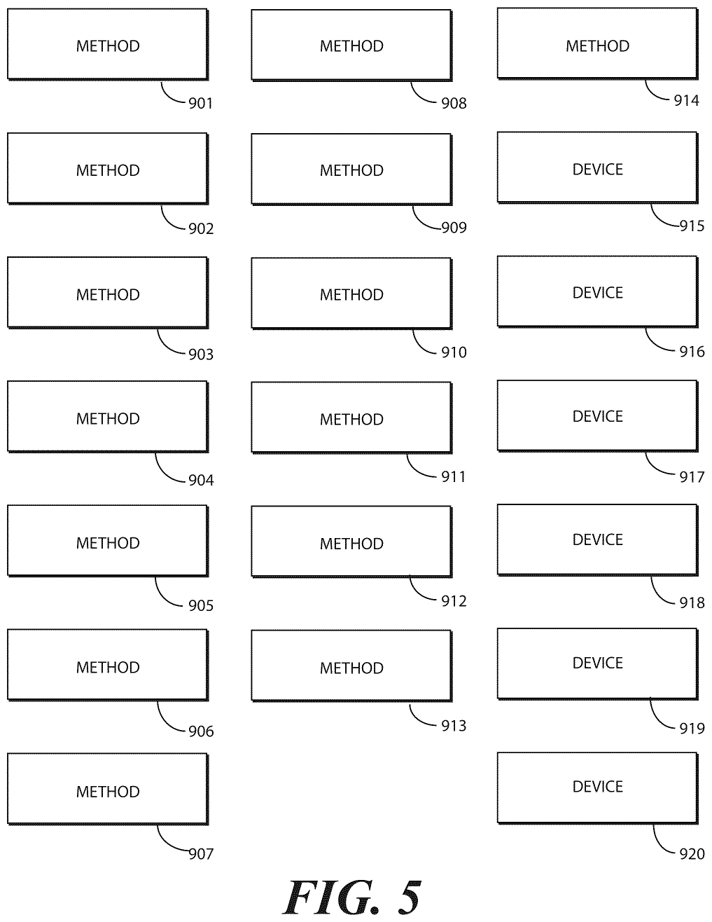

Turning now to FIG. 5, illustrated therein are various embodiments of the disclosure. The embodiments of FIG. 5 are shown as labeled boxes in FIG. 5 due to the fact that the individual components of these embodiments have been illustrated in detail in FIGS. 1A-1E and 2-4, which precede FIG. 5. Accordingly, since these items have previously been illustrated and described, their repeated illustration is no longer essential for a proper understanding of these embodiments. Thus, the embodiments are shown as labeled boxes.

At 901, a method in an electronic device comprises receiving, by a user interface, a swipe gesture across a graphical user interface of an application operating on one or more processors of the electronic device while a plurality of companion electronic devices is operating within an environment of the electronic device. At 901, the method comprises selecting, by the one or more processors, a companion electronic device of the plurality of companion electronic devices operating within the environment of the electronic device as a function of at least one predefined criterion. At 901, the method comprises transferring, by one or more processors using a communication device in response to the swipe gesture, operation of the application operating on the one or more processors to the companion electronic device identified by the one or more processors.

At 902, the at least one predefined criterion of 901 comprises a proximity to, and orientation of the electronic device in three-dimensional space relative to, the companion electronic device. At 903, the proximity of 902 is determined using an ultra-wide band ranging process. At 904, the proximity of 902 is determined using a Bluetooth channel sounding process.

At 905, the at least one predefined criterion of 901 comprises a determination of which companion electronic device of the plurality of companion electronic devices is most optimized to operate the application. At 906, the application of 905 comprises a music player application and the companion electronic device comprises a music player. At 907, the application of 905 comprises a productivity application and the companion electronic device comprises a computer. At 908, the application of 905 comprises a gaming application and the companion electronic device is operable by a gaming controller. At 909, the application of 905 comprises an audio/visual application and the companion electronic device comprises a television.

At 910, the at least one predefined criterion of 901 comprises a usage history of the application. At 911, the usage history of 910 is defined by a selected companion electronic device to which the operation of the application has been transferred from the electronic device in the past. At 912, the usage history of 911 is further defined by a time of day at which the operation of the application was transferred from the electronic device to the selected companion electronic device in the past.

At 913, the application of 901 operating on the one or more processors comprises a foreground application operating on an application stack. At 913, the method further comprises surfacing a penultimate application of the application stack on the user interface as a new foreground application after the transferring.

At 914, the method of 901 further comprises also receiving, by the user interface after the transferring, a predefined gesture. At 914, the method comprises recalling, by the one or more processors using the communication device in response to the predefined gesture, the operation of the application from the companion electronic device. At 914, the method comprises resuming, by the one or more processors, the operation of the application on the one or more processors of the electronic device.

At 915, an electronic device comprises a user interface, a communication device, and one or more processors operable with the user interface and communication device. At 915, the one or more processors, in response to the user interface receiving a swipe gesture across a surface of the user interface, prioritize a plurality of companion electronic devices as a function of at least one predefined criterion to select a companion electronic device from the plurality of companion electronic devices and cause the communication device to transfer operation of a foreground application operating on the one or more processors to the companion electronic device selected.

At 916, the one or more processors of 915 further cause the communication device to recall the operation of the foreground application from the companion electronic device in response to the user interface receiving another gesture input. At 917, the one or more processors of 915 cause an animation of a graphical user interface of the foreground application to move on the user interface while the communication device transfers the operation of the foreground application operating on the one or more processors to the companion electronic device selected.

At 918, a method in an electronic device comprises receiving, by a user interface, a swipe gesture instructing one or more processors of the electronic device requesting operation of a foreground application of an application stack be transferred to a companion electronic device operating in an environment of the electronic device. At 918, the method comprises selecting, by one or more processors, the companion electronic device from a plurality of companion electronic devices operating in the environment of the electronic device as a function of a selection criterion. At 918, in response to the swipe gesture the method comprises causing, by one or more processors using a communication device, operation of the foreground application of the application stack to be transferred to the companion electronic device selected using the selection criterion.

At 919, the selection criterion of 918 comprises one of proximity to, and orientation of the electronic device relative to, the companion electronic device, which companion electronic device of the plurality of companion electronic devices is optimized to operate the application, or a transfer history of the application from the electronic device. At 920, the method of 919 comprises animating, by the one or more processors, movement of a graphical user interface of the foreground application out of the application stack during the causing and surfacing, by the one or more processors, operation of a penultimate application of the application stack as a new foreground application after the causing.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a user interface, a swipe gesture across a graphical user interface of an application operating on one or more processors of the electronic device while a plurality of companion electronic devices is operating within an environment of the electronic device;
selecting, by the one or more processors, a companion electronic device from the plurality of companion electronic devices operating within the environment of the electronic device as a function of at least one predefined criterion; and
transferring, by one or more processors using a communication device in response to the swipe gesture, operation of the application operating on the one or more processors to the companion electronic device identified by the one or more processors.

2. The method of claim 1, wherein the at least one predefined criterion comprises a proximity to, and orientation of the electronic device in three-dimensional space relative to, the companion electronic device.

3. The method of claim 2, wherein the proximity is determined using an ultra-wide band ranging process.

4. The method of claim 2, wherein the proximity is determined using a Bluetooth channel sounding process.

5. The method of claim 1, wherein the at least one predefined criterion comprises a determination of which companion electronic device of the plurality of companion electronic devices is most optimized to operate the application.

6. The method of claim 5, wherein the application comprises a music player application and the companion electronic device comprises a music player.

7. The method of claim 5, wherein the application comprises a productivity application and the companion electronic device comprises a computer.

8. The method of claim 5, wherein the application comprises a gaming application and the companion electronic device is operable by a gaming controller.

9. The method of claim 5, wherein the application comprises an audio/visual application and the companion electronic device comprises a television.

10. The method of claim 1, wherein the at least one predefined criterion comprises a usage history of the application.

11. The method of claim 10, wherein the usage history is defined by a selected companion electronic device to which the operation of the application has been transferred from the electronic device in the past.

12. The method of claim 11, wherein the usage history is further defined by a time of day at which the operation of the application was transferred from the electronic device to the selected companion electronic device in the past.

13. The method of claim 1, wherein the application operating on the one or more processors comprises a foreground application operating on an application stack, further comprising surfacing a penultimate application of the application stack on the user interface as a new foreground application after the transferring.

14. The method of claim 1, further comprising:
also receiving, by the user interface after the transferring, a predefined gesture;
recalling, by the one or more processors using the communication device in response to the predefined gesture, the operation of the application from the companion electronic device; and
resuming, by the one or more processors, the operation of the application on the one or more processors of the electronic device.

15. An electronic device, comprising:
a user interface;
a communication device; and
one or more processors operable with the user interface and communication device;
wherein the one or more processors, in response to the user interface receiving a swipe gesture across a surface of the user interface, prioritize a plurality of companion electronic devices as a function of at least one predefined criterion to select a companion electronic device from the plurality of companion electronic devices and cause the communication device to transfer operation of a foreground application operating on the one or more processors to the companion electronic device selected.

16. The electronic device of claim 15, wherein the one or more processors further cause the communication device to recall the operation of the foreground application from the companion electronic device in response to the user interface receiving another gesture input.

17. The electronic device of claim 15, wherein the one or more processors cause an animation of a graphical user interface of the foreground application to move on the user interface while the communication device transfers the operation of the foreground application operating on the one or more processors to the companion electronic device selected.

18. A method in an electronic device, the method comprising:
receiving, by a user interface, a swipe gesture instructing one or more processors of the electronic device requesting operation of a foreground application of an application stack be transferred to a companion electronic device operating in an environment of the electronic device;
selecting, by one or more processors, the companion electronic device from a plurality of companion electronic devices operating in the environment of the electronic device as a function of a selection criterion; and
in response to the swipe gesture causing, by one or more processors using a communication device, operation of the foreground application of the application stack to be transferred to the companion electronic device selected using the selection criterion.

19. The method of claim 18, wherein the selection criterion comprises one of:
proximity to, and orientation of the electronic device relative to, the companion electronic device;
which companion electronic device of the plurality of companion electronic devices is optimized to operate the foreground application; or
a transfer history of the foreground application from the electronic device.

20. The method of claim 19, further comprising:
animating, by the one or more processors, movement of a graphical user interface of the foreground application out of the application stack during the causing; and
surfacing, by the one or more processors, operation of a penultimate application of the application stack as a new foreground application after the causing.
